(19) United States
(12) Patent Application Publication
(10) Pub. No.: US 2011/0128310 A1
(43) Pub. Date: Jun. 2, 2011

(54) ELECTRONIC DEVICE AND METHOD FOR ADJUSTING PIXEL CLOCK FREQUENCY THEREOF

(75) Inventors: Yu-Ren Yang, Taipei Hsien (TW); Yung-Sen Lin, Taipei Hsien (TW)

(73) Assignee: ACER INCORPORATED, Taipei Hsien (TW)

(21) Appl. No.: 12/820,391

(22) Filed: Jun. 22, 2010

(30) Foreign Application Priority Data
Nov. 27, 2009 (TW) 98140638

(51) Int. Cl. G09G 5/10; H04W 84/02

(52) U.S. Cl. 345/691; 370/338

(57) ABSTRACT

An electronic device and a method for adjusting a pixel clock frequency thereof are provided. The electronic device automatically detects whether or not the electronic device has a wireless communication module during a boot procedure. If the electronic device has the wireless communication module, the electronic device reads an adjustment parameter corresponding to a panel model of the electronic device through a lookup table stored in the electronic device and adjusts the pixel clock frequency according to the adjustment parameter so as to avoid generating harmonics of the panel pixel clock in an operating frequency band of the wireless communication module.

### CROSS-REFERENCE TO RELATED APPLICATION

This application claims the priority benefit of Taiwan application serial no. 98140638, filed on Nov. 27, 2009. The entirety of the above-mentioned patent application is hereby incorporated by reference herein and made a part of this specification.

### BACKGROUND OF THE INVENTION

1. Field of the Invention

The present invention relates to a method for adjusting a pixel clock frequency of a panel. More particularly, the present invention relates to a method for automatically adjusting a pixel clock frequency to avoid generating noises in an operating frequency band of a wireless communication module, and an electronic device using the same.

2. Description of Related Art

Along with quick development of wireless network technology, it is popular for electronic devices such as notebook computers and mobile phones, etc. to equip with wireless communication modules. Therefore, since a wireless network can transmit data through radio waves, it is more convenient than a cable network in hardware structure and utilization motility, and a user can access Internet or perform data transmission through a wireless approach without being limited by spaces and locations.

The wireless network has been gradually developed towards public wireless local area network (WLAN), and communication protocols for various WLANs are also quickly developed. Standards of the wireless communication technology are generally developed by specific industry organizations. For example, protocols of 802.11 and 802.16 are established by institute of electrical and electronics engineers (IEEE). The IEEE 802.11 contains a series of standards developed by an IEEE 802.11 committee, and the IEEE 802.11 committee establishes standards related to the WLAN. A part of the IEEE 802.11 standards specifies an interoperable method between a wireless receiver and a wireless transmitter.

Presently, the electronic devices can also be connected to networks through a wireless approach according to a 3G (3^{rd} generation) mobile communication technology provided by telecommunication service providers, and the 3G mobile communication technology has four standards of CDMA2000, WCDMA, TD-SCDMA and WiMAX. As long as a 3G wireless module is equipped, the electronic device can be connected to the Internet through a base station. However, since present portable electronic devices are all developed to have features of lightness, slimness, shortness and smallness, while an antenna of a wireless communication module is generally located near a panel, so that noises from the panel can easily influence a receiving sensitivity and a system performance of the wireless communication module. Especially, high-frequency harmonics of a pixel clock can generate noises in an operating frequency band of the wireless communication module, so that an operation performance of the wireless communication module is decreased. To resolve such problem, a current method is to use different extended display identification data (EDID) in collaboration with different panel models to adjust the pixel clock of the panel. However, such method can lead to a fact that a plurality of different EDID has to be prepared for a same panel model, which may cause an inventory risk of the EDID, and increase a fabrication cost of the wireless communication module.

### SUMMARY OF THE INVENTION

The present invention is directed to an electronic device capable of automatically adjusting a pixel clock frequency of a panel and a method thereof, in which whether the electronic device has a wireless communication module is automatically detected, and then a pixel clock suitable for the panel is found through a look-up table, so as to avoid generating harmonics of the pixel clock in an operating frequency band of the wireless communication module to influence a transceiving performance of the wireless communication module.

The present invention provides a method for adjusting pixel clock frequency, which is adapted to an electronic device having a panel, and the method includes following steps. First, a look-up table is established in the electronic device, and then internal data of the panel is read to obtain a panel model and a pixel clock. It is detected whether the electronic device has a wireless communication module, and if the electronic device has the wireless communication module, an adjustment parameter corresponding to the panel model is read from the look-up table, and then a frequency of the pixel clock transmitted to the panel is adjusted according to the adjustment parameter.

In an embodiment of the present invention, the look-up table includes a plurality sets of panel models and a plurality sets of adjustment parameters having corresponding relations. The look-up table is stored in a basic input/output system (BIOS) or a video graphics array BIOS (VBIOS) of a host. The electronic device further includes a display card, and the display card outputs the pixel clock to the panel, and adjusts the frequency of the pixel clock according to the adjustment parameter.

In an embodiment of the present invention, the wireless communication module includes a 3^{rd} generation (3G) mobile communication module or a worldwide interoperability for microwave access (WiMAX) module.

In an embodiment of the present invention, the internal data is extended display identification data (EDID). If the electronic device does not have the wireless communication module, the frequency of the pixel clock is determined according to the EDID of the panel.

The present invention provides an electronic device including a panel and a host. The panel has internal data, and the host is coupled to the panel and has a look-up table. When the host is booted, the host reads the internal data of the panel to obtain a panel model and a pixel clock, and detects whether the electronic device has a wireless communication module. If the electronic device has the wireless communication module, the host reads an adjustment parameter corresponding to the panel model from the look-up table, and adjusts a frequency of the pixel clock transmitted to the panel according to the adjustment parameter.

According to the above descriptions, the look-up table storing the panel models and the adjustment parameters of the corresponding pixel clocks is configured in the electronic device, and the electronic device can automatically set the frequency of the pixel clock during a boot procedure, so as to avoid generating noises of the pixel clock in the operating frequency band of the wireless communication module. Since the look-up table is stored in the host, data stored therein can be modified at any time, so that the EDID of the panel is unnecessary to be adjusted, and the electronic device can automatically set the frequency of the pixel clock through the look-up table according to different panel models, so as to avoid generating noises. Therefore, it is convenient for system design.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an electronic device according to a first embodiment of the present invention.

FIG. 2 is a flowchart illustrating a method for adjusting a pixel clock frequency of a panel according to a second embodiment of the present invention.

### DESCRIPTION OF THE EMBODIMENTS

### First Embodiment

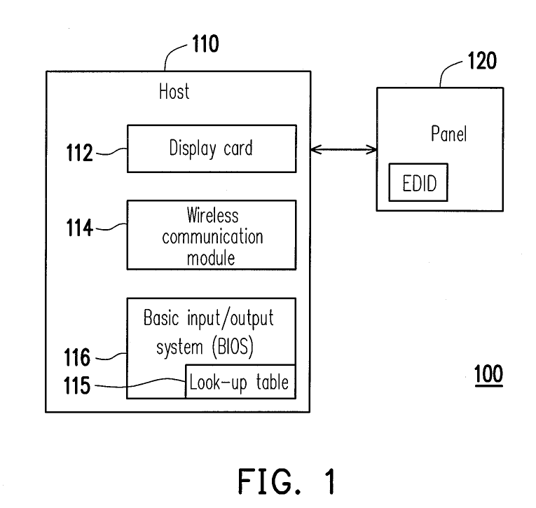

Referring to FIG. 1, FIG. 1 is a block diagram illustrating an electronic device according to a first embodiment of the present invention. The electronic device 100 includes a host 110 and a panel 120. The panel 120 is coupled to the host 110, and the host 110 includes a display card 112, a wireless communication module 114 and a basic input/output system (BIOS) 116. The BIOS 116 has a look-up table 115, and the look-up table 115 stores a plurality sets of panel models and a plurality sets of adjustment parameters corresponding to pixel clocks, wherein each of the panel models corresponds to an adjustment parameter, and the adjustment parameter can be used to set a frequency of the pixel clock. A user can modify data of the look-up table at any time according to a design requirement. The so-called pixel clock refers to a clock signal transmitted to the panel 120 by the host 110 or the display card 112, which can serve as a reference clock during the operation of the panel 120.

When the electronic device 100 is booted, the host 110 can read internal data (for example, extended display identification data (EDID)) of the panel 120 to obtain information such as a panel model, a specification and a setting value of the panel 120. The EDID is generally stored in an electrically erasable and programmable read only memory (EEPROM), though the present embodiment is not limited thereto. Moreover, during the booting process, the host 110 can detect whether the system has the wireless communication module 114, and if the system has the wireless communication module 114, the host 110 obtains a corresponding adjustment parameter from the look-up table 115 according to the panel model to replace a frequency of the pixel clock in the read EDID. The display card 112 of the host 110 adjusts the frequency of the pixel clock output to the panel 120 according to the adjustment parameter in the look-up table 115, so as to avoid generating harmonics or noises of the pixel clock in an operating frequency band of the wireless communication module 114 to influence a performance of the wireless communication module 114.

When the host 110 does not have the wireless communication module 114, the host 110 directly drives the panel 120 according to the read EDID, and the frequency of the pixel clock thereof is set according to the EDID of the panel 120 without changing. The so-called wireless communication module 114 refers to a wireless transmission device, for example, a wireless network interface card, a 3^{rd} generation (3G) mobile communication module or a worldwide interoperability for microwave access (WiMAX) module, etc., and the operating frequency band of the wireless communication module 114 is, for example, 869 MHz-894 MHz, 925 MHz-960 MHz, 1805 MHz-1880 MHz, 1930 MHz-1990 MHz and 2110 MHz-2170 MHz, though the present embodiment is not limited thereto.

Moreover, it should be noticed that the look-up table 115 can also be stored in a video graphics array BIOS (VGA BIOS) of the display card 114, so that a storage position of the look-up table 115 is not limited by the present embodiment as long as data in the look-up table 115 can be read when the host 110 is booted. Moreover, the BIOS 116 or other embedded chips in the system can be used to directly execute the operations of detecting whether the system has the wireless communication module 114 and adjusting the setting parameter of the pixel clock, which is not limited by the present embodiment.

An example of the look-up table 115 of the present embodiment is described with reference of a table 1, though the present embodiment is not limited to the table 1. Referring to the table 1, the table 1 is the look-up table 115 according to the first embodiment of the present invention.

TABLE 1

| | | Wireless | | | Pixel | |
|---|---|---|---|---|---|---|
| Manufacturer | | communication | | | clock | |
| ID | Panel model | module | Width | Height | (Hz) | Etc . . . |
| A | A000 | Module 1 | 1024 | 600 | 58 | . . . |
| | | Module 2 | | | 60 | . . . |
| A | A0001 | Module 1 | 1280 | 768 | 66.2 | . . . |
| | | Module 2 | | | 68 | . . . |
| B | LTS000 | Module 1 | 1024 | 600 | 59.3 | . . . |
| | | Module 2 | | | 61 | . . . |
| C | XYZEBSS | Module 1 | 1024 | 600 | 70 | . . . |
| | | Module 2 | | | 72 | . . . |
| D | 9834AB | Module 1 | 1024 | 600 | 67.7 | . . . |
| | | Module 2 | | | 69 | . . . |

The above table 1 includes different manufacturer IDs, different panel models, resolutions and adjustment parameters (frequencies) of the corresponding pixel clocks. It should be noticed that the table 1 also includes different wireless communication modules, and different frequencies of the pixel clock can be set when each panel model is used in collaboration with different wireless communication modules. Wherein, the frequency of the pixel clock can be obtained by calculating the operating frequency band of the wireless communication module and the frequency of the pixel clock, or the optimal adjustment parameters can be directly obtained through experiments. In the present embodiment, values and format settings thereof in the table 1 are only used as an example, and the present embodiment is not limited thereto. Other parameters, specifications and different corresponding relations can also be added to the table 1 according to a design requirement, so that the look-up table 115 is suitable for different panel models and electronic devices of different specifications and models. In the present embodiment, the electronic device 100 is, for example, a notebook computer or a mobile phone, though the present embodiment is not limited thereto.

Since data of the look-up table 115 can be modified or added at any time, it can be applied to electronic products of different models, and when a different model of the panel 120 is used, the host 110 can find a corresponding adjustment parameter to set the frequency of the pixel clock. In this way, it is unnecessary to add EDID of different models according to different types of the electronic device, and the host 110 can automatically adjust a suitable parameter to drive the panel 120, so as to avoid an EDID inventory risk. Moreover, it should be noticed that the technical approach of the present embodiment can also be used to adjust different EDID parameters, and is not limited to adjust the pixel clock.

### Second Embodiment

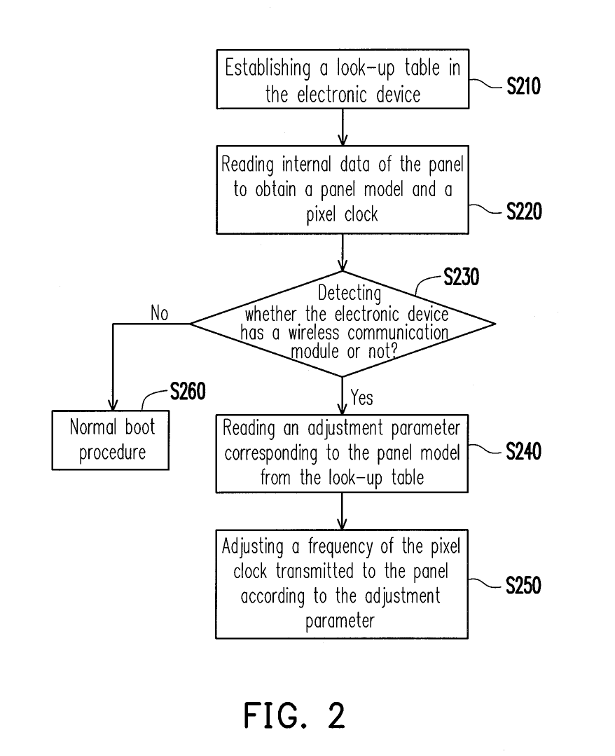

A method for adjusting a pixel clock frequency of a panel can be deduced according to the above embodiment. Referring to FIG. 2, FIG. 2 is a flowchart illustrating a method for adjusting a pixel clock frequency of a panel according to a second embodiment of the present invention. This method is adapted to an electronic device having a panel. The method includes following steps. First, a look-up table is established in the electronic device (step S210), wherein the look-up table has a plurality sets of panel models and a plurality sets of adjustment parameters having corresponding relations, and the adjustment parameter can be used to adjust a frequency of the pixel clock output to the panel. Then, internal data (i.e. EDID) of the panel is read to obtain parameters of a panel model and a pixel clock (step S220). Then, it is detected whether the electronic device has a wireless communication module (step S230), and if the electronic device has the wireless communication module, an adjustment parameter corresponding to the panel model is read from the look-up table (step S240), and then a frequency of the pixel clock transmitted to the panel is adjusted according to the adjustment parameter (step S250). If the electronic device does not have the wireless communication module, the electronic device is booted according to a normal boot procedure (step S260), and the panel is driven according to the EDID read from the panel.

The electronic device can automatically detect whether the wireless communication module is configured and the used panel model, and then obtain a suitable adjustment parameter from the look-up table to adjust the frequency of the pixel clock, so as to avoid the pixel clock influencing a receiving sensitivity of the wireless communication module. The look-up table can be updated at any time according to a design requirement, and new parameters can be added to the look-up table. In this way, the EDID parameter can be automatically adjusted according to different models of the electronic device without performing a hardware adjustment, so as to improve the performance of the electronic device. The first embodiment can be referred for other details of the method of the present embodiment, and detailed descriptions thereof are not repeated.

In summary, the look-up table is used to store various panel models and the adjustment parameters of the corresponding pixel clocks, so that the electronic device can automatically set the frequency of the pixel clock during the boot procedure, so as to avoid generating harmonics or noises of the pixel clock in the operating frequency band of the wireless communication module to influence the sensitivity and performance of the wireless communication module. Since the look-up table can be updated at any time, the technical approach of the present invention can be applied to electronic devices of different models without considering whether the EDID setting in the panel is suitable or not, and the electronic devices can automatically set the desired parameters, so that a design flow is simplified and the system design can be more efficiency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for adjusting pixel clock frequency, which is adapted to an electronic device having a panel, the method comprising:
establishing a look-up table in the electronic device;
reading internal data of the panel to obtain a panel model and a pixel clock;
detecting whether the electronic device has a wireless communication module;
reading an adjustment parameter corresponding to the panel model from the look-up table if the electronic device has the wireless communication module; and
adjusting a frequency of the pixel clock transmitted to the panel according to the adjustment parameter.

2. The method for adjusting the pixel clock frequency as claimed in claim 1, wherein the look-up table comprises a plurality sets of panel models and a plurality sets of adjustment parameters having corresponding relations.

3. The method for adjusting the pixel clock frequency as claimed in claim 1, wherein the electronic device comprises a display card, and the display card outputs the pixel clock to the panel, and adjusts the frequency of the pixel clock according to the adjustment parameter.

4. The method for adjusting the pixel clock frequency as claimed in claim 1, wherein the wireless communication module comprises a 3^{rd} generation (3G) mobile communication module or a worldwide interoperability for microwave access (WiMAX) module.

5. The method for adjusting the pixel clock frequency as claimed in claim 1, wherein the internal data is extended display identification data (EDID).

6. The method for adjusting the pixel clock frequency as claimed in claim 5, wherein if the electronic device does not have the wireless communication module, the frequency of the pixel clock is determined according to the internal data.

7. The method for adjusting the pixel clock frequency as claimed in claim 1, wherein the look-up table is stored in a basic input/output system (BIOS) or a video graphics array BIOS (VBIOS) of a host.

8. An electronic device, comprising:
a panel, having internal data, and the internal data at least comprising a panel model and a pixel clock; and
a host, coupled to the panel and having a look-up table,
wherein when the host is booted, the host reads the internal data of the panel to obtain the panel model and the pixel clock, and detects whether the electronic device has a wireless communication module, and if the electronic device has the wireless communication module, the host reads an adjustment parameter corresponding to the panel model from the look-up table, and adjusts a frequency of the pixel clock transmitted to the panel according to the adjustment parameter.

9. The electronic device as claimed in claim 8, wherein the look-up table comprises a plurality sets of panel models and a plurality sets of adjustment parameters having corresponding relations.

10. The electronic device as claimed in claim 8, further comprising a display card, wherein the display card outputs the pixel clock to the panel, and adjusts the frequency of the pixel clock according to the adjustment parameter.

11. The electronic device as claimed in claim 8, wherein the wireless communication module comprises a 3^{rd} generation (3G) mobile communication module or a worldwide interoperability for microwave access (WiMAX) module.

12. The electronic device as claimed in claim 8, wherein the internal data is extended display identification data (EDID).

13. The electronic device as claimed in claim 12, wherein if the electronic device does not have the wireless communication module, the host determines the frequency of the pixel clock according to the internal data of the panel.

14. The electronic device as claimed in claim 8, wherein the host comprises a basic input/output system (BIOS) for storing the look-up table.

15. The electronic device as claimed in claim 8, wherein the host comprises a video graphics array BIOS (VBIOS) for storing the look-up table.
